(19) United States
(12) Patent Application Publication
(10) Pub. No.: US 2016/0109649 A1
(43) Pub. Date: Apr. 21, 2016

(54) DISPLAY DEVICE AND METHOD FOR DETECTING BACKLIGHT LIGHT FROM SAME

(71) Applicant: NEC DISPLAY SOLUTIONS, LTD., Tokyo (JP)

(72) Inventor: Akio Ishiwata, Tokyo (JP)

(21) Appl. No.: 14/894,476

(22) PCT Filed: May 31, 2013
(86) PCT No.: PCT/JP2013/065215

§ 371 Date: Nov. 27, 2015

(51) Int. Cl. F21V 8/00

(52) U.S. Cl. CPC G02B 6/0091

(57) ABSTRACT

A liquid crystal display device includes a liquid crystal panel, a light-guiding plate, a light source, and an optical sensor. The light source is attached to an end face of a bottom of the light-guiding plate so as to emit light, which is guided into the light-guiding plate so as to illuminate the liquid crystal panel. The optical sensor having a photo-acceptance part is attached to a rear face of a chassis so as to partially detect light. A panel opening is formed by attaching a gobo to an opening formed in the chassis at a side end of the light-guiding plate, thus regulating the range of light received with the photo-acceptance part of the optical sensor. Thus, it is possible to precisely detect the intensity of light by use of the panel opening which eliminates high-intensity light reflected by an edge-reflection sheet of the light-guiding plate.

### TECHNICAL FIELD

The present invent-ion relates to a display device and a method for detecting a backlight of a display device, which is designed to detect luminance values of backlights in various types of display devices such as liquid crystal display devices.

### BACKGROUND ART

Liquid crystal display devices are equipped with backlights on rear faces of display screens, thus illuminating display screens with light and displaying characters and images. Such display devices undergo aged deterioration in light sources, which reduces the intensity of light. For this reason, engineers have developed a technology which detects light of a light source illuminating a display screen by use of an optical sensor and which controls the intensity of light of a light source depending on the detected light so as to maintain an adequate display condition and an adequate illumination condition.

For example, Patent Literature Document 1 discloses an optical detector unit of a liquid crystal display device including an optical detection unit which is bonded to the center of a reflection sheet on the rear face of a liquid crystal display device, thus detecting any light that leaks from the reflection sheet. This document also discloses a mechanism which controls an emission value of a light source in order for a user to observe a display screen with the predetermined luminance relative to the luminance detected by the optical detector. An optical detector can be easily installed in any type of liquid crystal display device which is normally sold as a packaged type integrating a liquid crystal panel, a light-guiding plate, and a reflection sheet; hence, the installation cost thereof is low.

The liquid crystal display devices, like the liquid crystal display disclosed in Patent Literature Document 1, are normally sold using a chassis including a liquid crystal panel, a light-guiding plate, and a reflection sheet. In fact, Patent Literature Document 1 discloses a configuration of attaching an optical detector unit to another type of a liquid crystal display device whose parts are not kept in a chassis. To apply the optical detector disclosed in Patent Literature Document 1 to a liquid crystal display device equipped with a chassis, it is necessary to form an opening at the center of a chassis so as to attach the optical detector unit to the opening. This causes a problem due to leakage of light via an opening, and therefore a user may see a shadow being cast on the periphery of an opening when looking at a display screen on a front face. By forming an opening in a chassis at a position on the edge of a light-guiding plate, it is possible to project light on a display screen without damaging the display quality.

### CITATION LIST

### Patent Literature Document

Patent Literature Document 1: Japanese Patent Application Publication No. H10-222084

### SUMMARY OF INVENTION

### Technical Problem

Display devices are often set up by turning liquid crystal monitors for rotatable computers and display screens of displays for digital signage into horizontally-long (landscape) orientations or vertically-long (portrait) orientations. FIGS. 6A and 6B show examples of display devices which are used to show the relationship of relative positioning between a light-guiding plate 101 and an opening 102 due to rotation of a liquid crystal display device 100. Herein, an optical detector is attached to a position opposite to the opening 102 at the edge of the light-guiding plate 101.

The liquid crystal display device 100 allows for a small movement of the light-guiding plate 101 made of an acrylic plate due to thermal expansion or water-absorbing expansion. For this reason, the light-guiding plate 101 may be moved by a small distance, e.g. several millimeters, in a gravitational direction due to rotation of the liquid crystal display device 100 as shown in FIG. 6A, thus changing the relative positioning between the light-guiding plate 101 and the opening 102 as shown in FIG. 6B. This causes a variance in the intensity of light detected by an optical detector positioned at the opening 102.

Specifically, a reflection sheet attached to the edge of the light-guiding plate 101 produces a high reflection rate. This causes a drawback in that, when the liquid crystal display device 100 is turned from a landscape orientation to a portrait orientation, an optical detector corresponding to the upper opening of FIG. 6B may detect light reflected by the reflection sheet attached to the edge of the light-guiding plate 101 so as to detect brighter light than the light detected in a landscape orientation.

Despite the above phenomenon occurring due to the opening 102 being formed at the edge of the light-guiding plate 101, it is possible to maintain the same display orientation over a large portion of a screen displaying a video without causing any change in luminance even when the liquid crystal display device 100 is turned from a landscape orientation to a portrait orientation. However, the conventional art suffers from another problem in that the display condition cannot be stabilized due to the function of controlling the brightness of a screen when an optical detector detects the intensity of light which may be increased or decreased due to the transition between a landscape orientation and a portrait orientation and due to the reception of a light reflected by a reflection sheet.

Additionally, the conventional art suffers from a further problem in that, when the liquid crystal display device 100 is turned between a landscape orientation and a portrait orientation, for example, a light-emitting position may be shifted from each of single-color sensors, i.e. RGB color sensors arrayed in a matrix at a photo-acceptance part of an optical sensor in the opening 102 having a circular shape. This may change a photo-acceptance ratio for each single-color sensor so as to increase or decrease the intensity of light detected by an optical detector.

The present invention is made in consideration of the above problems, and therefore it is an object of the invention to provide a display device and a method of detecting a backlight of a display device, which aims to prevent any variance in the intensity of light detected by an optical sensor irrespective of the movement of a light-guiding plate.

### Solution To Problem

The present invention is directed to a display device in which light emitted from a light source positioned opposite to part of the edge of a light-guiding plate is guided into the light-guiding plate so as to illuminate a liquid crystal panel. The display device includes a chassis covering the light-guiding plate and the light source; a light-transmitting opening formed in the chassis at the edge of the liquid crystal panel; and an optical sensor configured to detect the light output from the light-guiding plate through the light-transmitting opening, wherein the light-transmitting opening has a rectangular shape.

The present invention is directed to a backlight detecting method adapted to a display device in which light emitted from a light source positioned opposite to part of the edge of a light-guiding plate is guided into the light-guiding plate so as to illuminate a liquid crystal panel. Herein, a light-transmitting opening having a rectangular shape is formed in a chassis covering the light source and the light-guiding plate at the edge of the liquid crystal panel. An optical sensor is used to receive the light reflected by the light-guiding plate so as to detect the amount of received light.

### Advantageous Effects Of Invention

According to a display device and a method of detecting a backlight of a display device according to the present invention, it is possible to achieve an effect of stably maintaining the intensity of light detected by an optical sensor through a light-transmitting opening having a rectangular shape irrespective of the transformation of a display screen between a landscape orientation and a portrait orientation.

### BRIEF DESCRIPTION OF DRAWINGS

FIG. 1 is an explanatory drawing showing a liquid crystal display device according to the embodiment of the present invention.

FIG. 2 is a plan view showing essential parts in the configuration of an optical detector for the liquid crystal display device shown in FIG. 1.

FIG. 3 is an enlarged view showing a photo-acceptance part of an optical sensor shown in FIG. 2.

FIG. 4 is an explanatory drawing showing the positional relationship between an opening formed in a chassis of a liquid crystal display device at a landscape orientation, a panel opening equipped with a gobo, and an optical sensor.

FIG. 5 is an explanatory drawing showing the positional relationship between an opening formed in a chassis of a liquid crystal display device at a portrait orientation, a panel opening equipped with a gobo, and an optical sensor.

FIG. 6A shows the relationship between an opening and a setup orientation of the conventional liquid crystal display device, i.e. a drawing showing the positional relationship between a display screen at a landscape orientation and the edge of a light-guiding plate overlapping an opening with an enlarged view.

FIG. 6B is a drawing showing the positional relationship between a display screen at a portrait orientation and a light-guiding plate overlapping an opening with an enlarged view.

### DESCRIPTION OF EMBODIMENT

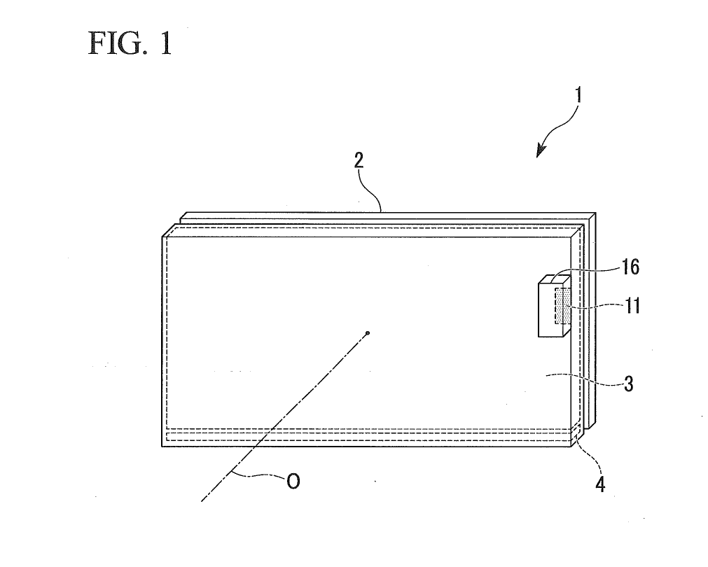

Hereinafter, an optical detector for a liquid crystal display device according to the embodiment of the present invention will be described with reference to FIGS. 1 to 5.

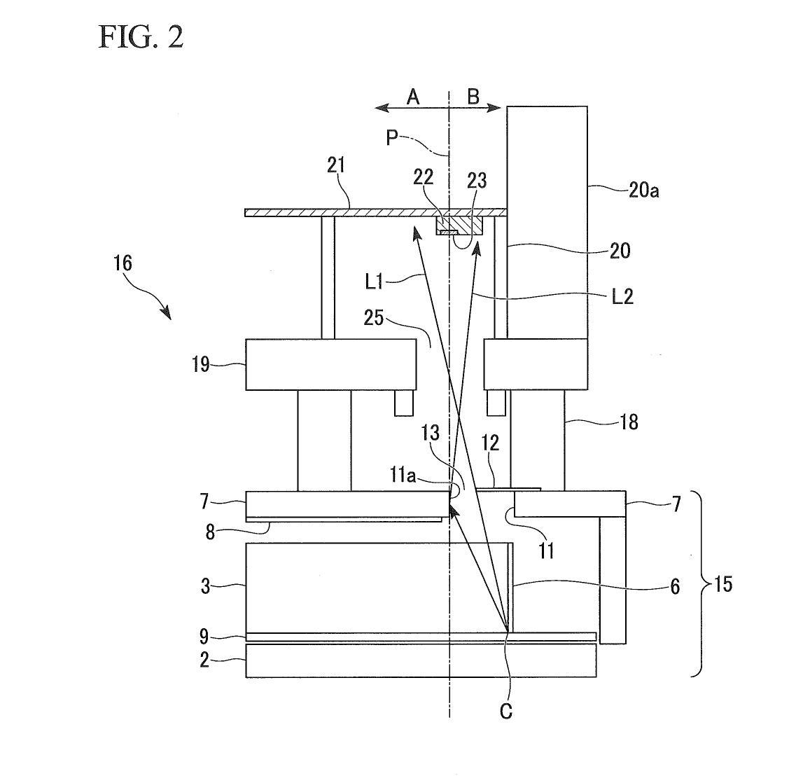

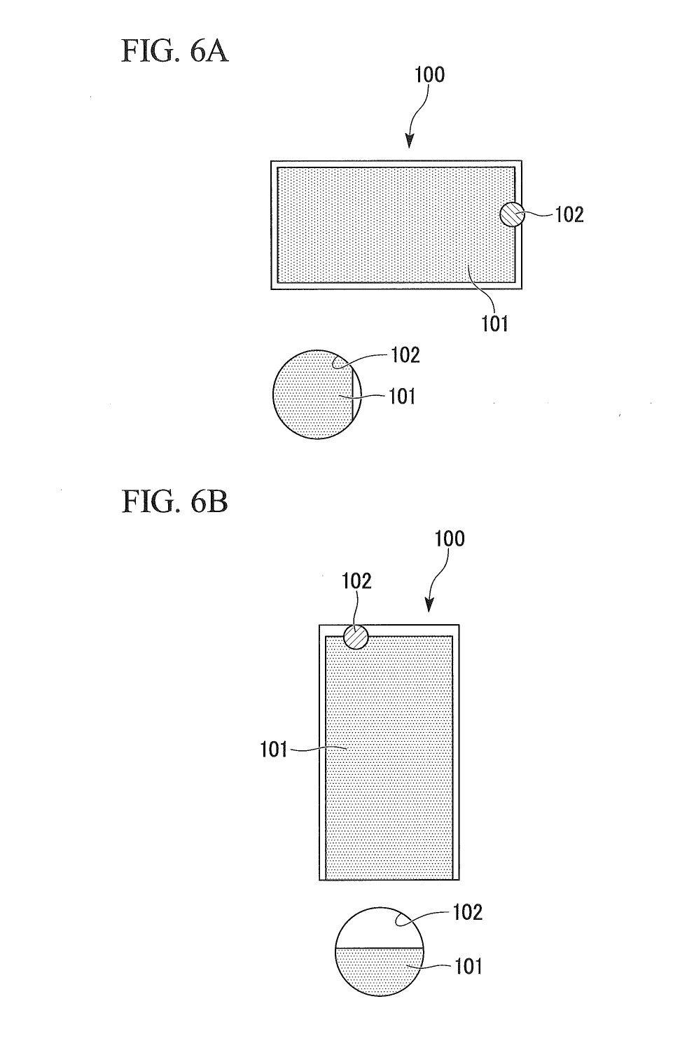

According to the embodiment of the present invention shown in FIGS. 1 and 2, a liquid crystal display device 1 includes a liquid crystal panel 2, serving as a display screen, and a light-guiding plate 3 attached to the rear face. For example, the liquid crystal panel 2 and the light-guiding plate 3 are rectangular plates having rectangular shapes; hence, a user (or an observer) can observe the liquid crystal panel 2 by setting up the liquid crystal panel 2 in a horizontally-long (landscape) orientation as shown in FIG. 6A or in a vertically-long (portrait) orientation as shown in FIG. 6B. In FIGS. 1 and 2, the liquid crystal panel 2 is set up in a horizontally-long (landscape) orientation.

In FIGS. 1 and 2, a light source 4 is disposed along the edge of a bottom, made of a long side of the light-guiding plate 3, in a longitudinal direction. For example, LEDs are used for the light source 4. A edge-reflection sheet 6 (i.e. a first optical member) is bonded to a side-end face made of one or both of short sides adjoining the edge face of a bottom arranging the light source 4 among four edge faces constituting the light-guiding plate 3. A chassis 7 made of an aluminum alloy and serving as an LCD-panel metal frame is placed on the rear face of the light-guiding plate 3. A back-reflection sheet 8 (i.e. a second optical member) is attached to the face of the chassis 7 opposite to the rear face of the light-guiding plate 3. The back-reflection sheet 8 is separated from the rear face of the light-guiding plate 3, although it can also be placed in contact with the rear face of the light-guiding plate 3. Alternatively, the back-reflection sheet 8 can be attached to the rear face of the light-guiding plate 3. The light-guiding plate 3 and the light source 4 are covered with the chassis 7.

The light emitted from the light source 4 enters into the inside of the light-guiding plate 3 from the edge face of a bottom of the light-guiding plate 3. Part of the light entering into the light-guiding plate 3 is reflected by the edge-reflection sheet 6 while another part of the light is emitted from the rear face of the light-guiding plate 3, reflected by the back-reflection sheet 8, forced to re-enter into the light-guiding plate 3, and then emitted from the front face of the light-guiding plate 3. Thus, the light inside the light-guiding plate 3 is emitted from the front face, diffused and converged by a diffusion plate 9 and an optical sheet, and then transmitted through the entire front face of the liquid crystal panel 2, thus illuminating the liquid crystal panel 2.

An opening 11 used to transmit detection light is formed in the chassis 7 at a position opposite to the side end of the light-guiding plate 3. A gobo 12 used to regulate the range of light which is reflected by the light-guiding plate 3 and then guided backwardly through the opening 11 is attached to the chassis 7 while partially covering the opening 11. Even when the edge of the light-guiding plate 3 is shifted from the original position during the transformation of the liquid crystal display device 1 between a landscape orientation and a portrait orientation, the light reflected by the edge-reflection sheet 6 is blocked by the gobo 12, and therefore the reflected light will not reach a photo-acceptance part 23 of an optical sensor, which will be described later. Herein, the range of an optical pathway formed by the gobo 12 and the opening 11 of the chassis 7 will be referred to as a panel opening 13 (i.e. a light-transmitting opening). The opening 11 and the panel opening 13 are formed in rectangular shapes. One side of the gobo 12 is positioned approximately in parallel with the long side of the opening 11. The light-transmitting range of the panel opening 13 formed by the opening 11 and the gobo 12 is determined to regulate the range between an internal plane including an internal light L1 and an external plane including an external light L2. The opening 11 is formed using dimensions concerning the short side by the long side, e.g. 2.5 mm×5 mm. A portion of the liquid crystal display device 1 ranging from the liquid crystal panel 2 to the chassis 7 through the light-guiding plate 3 will be referred to as a liquid crystal module 15.

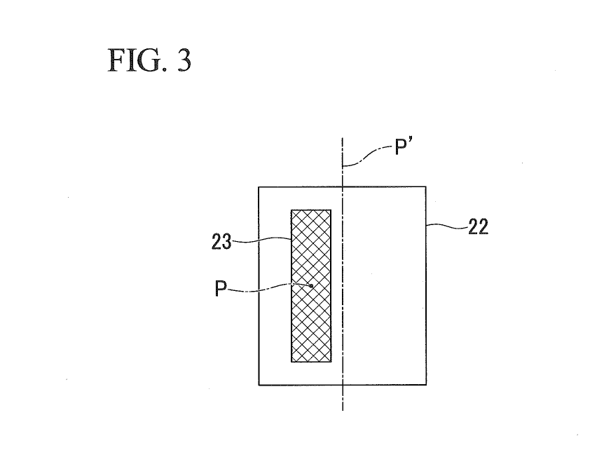

An optical detector 16 covering the opening 11 is attached to the chassis 7 at the rear end of the liquid crystal module 15. In the optical detector 16, a cover member 18 having a cylindrical shape and made of a sponge-like material is attached to the rear face of the chassis 7. A sponge-like material which is able to expand or contract is used to prevent any gaps from being formed between the chassis 7 and the cover member 18 since the light quantity of the received light will vary due to any contaminants entering the cover member 18. An optical sensor holder 20 having a cylindrical shape is attached to the rear end of the cover member 18 via a plate-shaped holder 19 made of plastics, while a supporting member 20a is attached to one side of the optical sensor holder 20. Additionally, the optical sensor 22 is fixed to the interior face of an optical sensor substrate 21 which is attached to the rear end of the optical sensor holder 20. In FIG. 3, a set of three types of single-color sensors corresponding to three colors R, G, and B is arrayed in a matrix in the square-shaped photo-acceptance part 23 of the optical sensor 22. The photo-acceptance part 23 is positioned inwardly of a center line P′ of the optical sensor 22, i.e. close to a center line O of the liquid crystal panel 2 having a rectangular-plate shape.

In the optical detector 16, an optical sensor holder opening 25 whose diameter is larger than the diameter of the panel opening 13 is formed in the holder 19 so as to transmit the light transmitted through the panel opening 13 of the chassis 7. A wall face 11a along the long side of the opening 11 formed in the chassis 7 is placed in contact with a normal line P passing through the midpoint of the photo-acceptance part 23. In FIG. 2, a direction A refers to the inward direction of the liquid crystal panel 2 relative to the normal line P while a direction B refers to the outward direction. In this connection, the wall face 11a of the opening 11 is not necessarily formed at a position overlapping the normal line P.

It is possible to assume that part of the light which is emitted by the light source 4 and forced to enter into the light-guiding plate 3 is reflected in proximity to the edge-reflection sheet 6, corresponding to one side of the light-guiding plate 3, transmitted through the panel opening 13, and then forced to be incident on the photo-acceptance part 23 of the optical sensor 22 in the optical detector 16. In the light incident on the photo-acceptance part 23, part of the light reflected by the edge-reflection sheet 6 may have a higher luminance than another part of the light not reflected by the edge-reflection sheet 6, and therefore it can be seem as a secondary light source. Additionally, the light-guiding plate 3 may be moved in position due to the transformation of the liquid crystal panel 2 between a landscape orientation and a portrait orientation. This may vary the light reflected by the edge-reflection sheet 6 so as to vary the intensity of light detected by the photo-acceptance part 23. Therefore, it is necessary to regulate the light reflected by the edge-reflection sheet 6 from being incident on the photo-acceptance part 23.

In FIG. 2, it is necessary to determine the edge position of the gobo 12 such that the gobo 12 will be protruded in the opening 11 and fixed to the chassis 7, thus controlling the light L1, which is reflected at a boundary position C between the edge of the light-guiding plate 3 and the edge-reflection sheet 6 and then transmitted through the panel opening 13, not to be incident on the photo-acceptance part 23 of the optical sensor 22 but to be transmitted inwardly (i.e. a direction A). The light L1 will be referred to as an internal light L1. In other words, it is necessary to determine the installation position of the gobo 12 such that the extension line (i.e. the internal light L1) connected between the position C of the light-guiding plate 3 and the distal end of the gobo 12 will deviate from the photo-acceptance part 23. Additionally, the photo-acceptance part 23 should be positioned externally (i.e. a direction B) of the internal light L1.

The light, which is emitted from the boundary position C between the surface of the light-guiding plate 3 and the edge-reflection sheet 6, reflected by the wall face 11a of the opening 11 formed in the chassis 7, and then transmitted toward the proximity of the photo-acceptance part 23, will be referred to as an external light L2 which propagates externally (i.e. the direction B) of the photo-acceptance part 23 of the optical sensor 22. In other words, the photo-acceptance part 23 should be positioned inwardly (i.e. the direction A) of the external light L2.

Additionally, it is necessary to determine the panel opening 13 such that the reflected light propagating within the range embracing the internal plane including the internal light L1 and the external plane including the external light L2 can be incident on the photo-acceptance part 23, which is thus located within the range. For this reason, the light reflected by the edge-reflection sheet 6 deviates from the range embracing the internal plane including the internal light L1 and the external plane including the external light L2, and therefore the reflected light will not be incident on the photo-acceptance part 23 of the optical sensor 22. Additionally, it is preferable to determine the internal diameter of the optical sensor holder opening 25 such that the light, which belongs to the light reflected by the edge-reflection sheet 6 and which propagates within the range embracing the internal plane including the internal light L1 and the external plane including the external light L2, will not be regulated by the optical sensor holder opening 25. In this connection, the panel opening 13 can be formed solely using the opening 11 of the chassis 7.

In the present embodiment, the external light L2 reflected by the wall face 11a of the opening 11 may be reflected diffusely by the chassis 7 made of an aluminum alloy. For this reason, it is preferable to eliminate erroneous detection by slightly increasing the distance between the photo-acceptance part 23 and the external plane including the external light L2. Pertaining to the position of forming the opening 11 in the chassis 7, a positioning notch (not shown) used to discriminate the front and rear faces of the back-reflection sheet 8 at the installation is formed at the edge of the back-reflection sheet 8, but the notch overlapping the opening 11 will affect the light quantity of the received light at the optical sensor 22. For this reason, the opening 11 should be formed at the edge of the chassis 7 at the position opposite to the notchless portion of the back-reflection sheet 8.

In the liquid crystal display device 1 of the present embodiment, the optical detector 16 has the aforementioned configuration. Next, the optical detector 16 will be described with respect to the optical detection method.

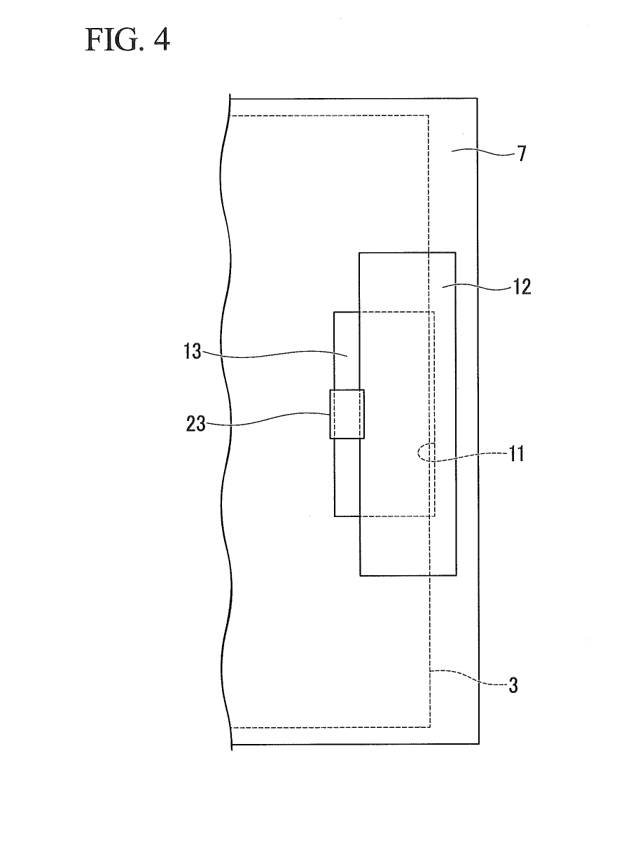

The liquid crystal display device 1 is set up in a horizontally-long (landscape) orientation as shown in FIGS. 2 and 4. Upon starting the liquid crystal display device 1, the light emitted from the light source 4 is transmitted through and reflected by the light-guiding plate 3, reflected by the edge-reflection sheet 6 and the back-reflection sheet 8, emitted forwards from the light-guiding plate 3, transmitted through and disused by the diffusion plate 9 and the optical sheet, and then transmitted through the liquid crystal panel 2; this allows a user to observe an image on the liquid crystal panel 2. The external part of the opening 11 formed in the chassis 7 is partially covered with the gobo 12, and therefore the light-guiding plate 3 is entirely positioned opposite to one side of the panel opening 13 having a square shape while the photo-acceptance part 23 of the optical sensor 22 is positioned opposite to the other side of the panel opening 13. Part of the light incident on the light-guiding plate 3 is reflected by the light-guiding plate 3, transmitted through the panel opening 13, and then incident on and received by the photo-acceptance part 23 of the optical sensor 22.

At this time, part of the light reflected by the edge-reflection sheet 6 is transmitted through the panel opening 13 of the opening 11 and further transmitted towards the optical sensor 22, whereas the light transmitted in proximity to the gobo 12 of the panel opening 13 propagates inwardly (i.e. the direction A) of the internal plane including the internal light L1 and thus deviates from the photo-acceptance part 23. Additionally, the light, which is reflected by the wall face 11a of the opening 11 of the chassis 7 and then transmitted through the panel opening 13, propagates externally (i.e. the direction B) of the external plane including the external light L2 and thus deviates from the photo-acceptance part 23. For this reason, the light incident on the photo-acceptance part 23 of the optical sensor 22 falls within the range between the internal light L1 and the external light L2, and therefore at least the light reflected by the edge-reflection sheet 6 is cut out and partitioned by the section formed between the wall face 11a of the opening 11 and the gobo 12 regulating the panel opening 13. For this reason, the reflected light having a high intensity at the edge-reflection sheet 6 serving as a secondary light source is eliminated from the light incident on the photo-acceptance-part 23, and therefore it is possible to precisely detect the brightness of the liquid crystal panel 2 by preventing dispersions in intensity with respect to the light detected by the photo-acceptance part 23. When the light received by the photo-acceptance part 23 is reduced in terms of the intensity of light, a control means, not shown, determines degradation of the light source 4 so as to increase a current supplied to the light source 4, thus increasing the brightness of the liquid crystal panel 2.

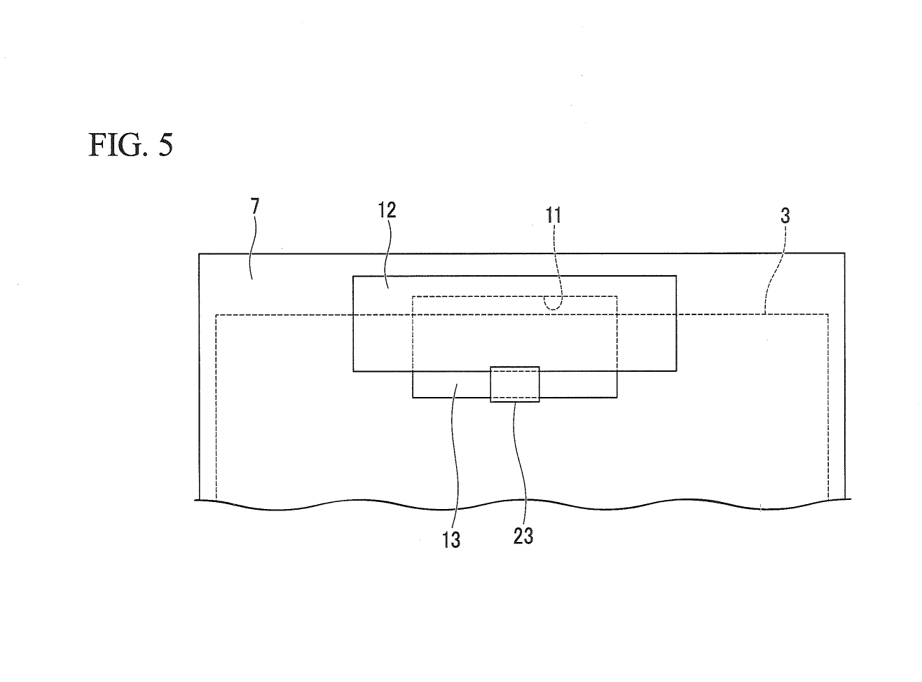

When the liquid crystal display device 1 of the present embodiment is changed from a landscape orientation to a portrait orientation, as shown in FIG. 5, both the panel opening 13 and the opening 11 of the chassis 7 formed in the side end of the light-guiding plate 3 are changed in position to the upper end of the liquid crystal display device 1. Additionally, the light-guiding plate 3 slightly moves down due to its own weight by several millimeters. Accordingly, the upper end of the light-guiding plate 3 slightly moves down relatively to the opening 11, whereas the panel opening 13 is entirely positioned opposite to the light-guiding plate 3 since the upper end of the opening 11 is covered with the gobo 12.

Therefore, it is possible to prevent the light, which is reflected by the light-guiding plate 3, transmitted through the panel opening 13, and then received by the photo-acceptance part 23, from being varied in intensity even when the liquid crystal display device 1 is transformed from a landscape orientation to a portrait orientation. Similar to the landscape orientation, it is possible to eliminate the reflected light having a high intensity of light at the edge-reflection sheet 6 serving as a secondary light source, and therefore it is possible to precisely detect the brightness of the liquid crystal panel 2 by preventing dispersions in intensity with respect to the light detected by the photo-acceptance part 23.

The liquid crystal display device 1 of the present embodiment employs the rectangular-shaped photo-acceptance part 23 of the optical sensor 22 and the rectangular-shaped panel opening 13 transmitting the light used to detect a photo-acceptance value, wherein the side of the photo-acceptance part 23 is positioned opposite to and in parallel with the side of the panel opening 13. Additionally, the side of the panel opening 13 is positioned in parallel to the side end of the light-guiding plate 3. Despite any deviation occurring in the boundary of the light transmitted through the panel opening 13 and then incident on the photo-acceptance part 23 in the liquid crystal display device 1 which is set up in either a landscape orientation or a portrait orientation, it is possible to maintain a constant ratio between quantities of light incident on color sensors without causing any variance in the ratio between the intensities of the received light since a set of single-color sensors of R, G, B colors is arrayed in a matrix in the photo-acceptance part 23 having a rectangular shape, and therefore it is possible to precisely detect light while reducing dispersions in the intensity of light.

As described above, according to the liquid crystal display device 1 of the present embodiment, it is possible to prevent inputting the light from the edge of the light-guiding plate 3 irrespective of any positional shift of the light-guiding plate 3 occurring when the liquid crystal display device 1 is transformed into either a landscape orientation or a portrait orientation, and therefore it is possible to precisely detect the intensity of light since no variation occurs in the intensity of the light received by the photo-acceptance part 23 of the optical sensor 22.

The photo-acceptance part 23 of the optical sensor 22 has a square shape while the panel opening 13 transmitting the light reflected by the light-guiding plate 3 has a square shape parallel to the side of the photo-acceptance part 23. Even when the liquid crystal display device 1 is transformed between a landscape orientation and a portrait orientation, it is possible to maintain a constant ratio between quantities of light incident on single-color sensors of R, G, B colors arrayed in a matrix. Compared to an opening having a circular shape, it is possible to prevent any variance occurring in the ratio between quantities of received light, thus achieving high-precision detection.

The present invention is not necessarily limited to the liquid crystal display device 1 of the present embodiment; hence, it is possible to make appropriate modifications and replacements without departing from the essential matter of the present invention since such modifications and replacements are embraced by the present invention.

For example, the liquid crystal display device 1 of the present embodiment is described such that the light source 4 is disposed at the lower end face of the light-guiding plate 3 at a landscape orientation. To increase the luminance of the liquid crystal panel 2, it is possible to arrange the light source 4 at the lower face and the upper face of the light-guiding plate 3, or it is possible to arrange the light source 4 at the side face of the light-guiding plate 3. When a driver used to drive the liquid crystal panel 2 is attached to one end face of the light-guiding plate 3, it is preferable to prevent the end face equipped with a driver from circumventing the opening 11. Considering an influence on the optical sensor 22 due to temperature, it is preferable to attach the optical sensor 22 to another end face other than the end face equipped with the light source 4 and a driver, i.e. a position which deviates from the light source 4 so as to undergo small temperature variation.

In the present embodiment, the panel opening 13 configured to regulate the range of the light incident on the photo-acceptance part 23 is formed using the opening 11 and the gobo 12, wherein the gobo 12 can be adjusted in terms of the installation position. In this connection, it is possible to form the opening 11 without installing the gobo 12 such that the light-guiding plate 3 is entirely positioned opposite to the opening 11 so as to prevent the photo-acceptance part 23 from receiving the light reflected by the edge-reflection sheet 6 even when the liquid crystal display device 1 is transformed between a landscape orientation and a portrait orientation.

The foregoing embodiment of the present invention is described using the liquid crystal display device 1, but the present invention is not necessarily limited to liquid crystal display devices; hence, the present invention is applicable to various types of display devices. In the present invention, the light-transmitting opening embraces the panel opening 13.

### REFERENCE SIGNS LIST

1 liquid crystal display device
2 display screen
3 light-guiding plate
6 edge-reflection sheet
7 chassis
8 back-reflection sheet
9 diffusion plate
11 opening
11a wall face
12 gobo
13 panel opening
15 liquid crystal module
16 optical detector
22 optical sensor
23 photo-acceptance part

1. A display device in which light emitted from a light source positioned opposite to part of an edge of a light-guiding plate is guided into the light-guiding plate so as to illuminate a liquid crystal panel, comprising:
a chassis covering the light-guiding plate and the light source;
a light-transmitting opening formed in the chassis at an edge of the liquid crystal panel; and
an optical sensor configured to detect the light output from the light-guiding plate through the light-transmitting opening,
wherein the light-transmitting opening has a rectangular shape.

2. The display device according to claim 1, wherein a photo-acceptance part of the optical sensor is positioned outside an internal place including an extension line connected between the edge of the light-guiding plate and one side of the light-transmitting opening.

3. The display device according to claim 1, wherein a photo-acceptance part of the optical sensor is positioned inside an external plane including the light which is emitted from the edge of the light-guiding plate and then reflected at a wall face of the light-transmitting opening.

4. The display device according to claim 1, wherein the light-transmitting opening is formed in a rear face of the edge of the light-guiding plate which is not positioned opposite to the light source.

5. The display device according to claim 1, wherein a photo-acceptance part of the optical sensor is formed in a rectangular shape, and wherein one side of the photo-acceptance part is formed in parallel with one side of the light-transmitting opening.

6. The display device according to claim 1, further comprising a first optical member which is attached to the edge of the light-guiding plate so as to reflect the light.

7. The display device according claim 1, further comprising a second optical member which is interposed between the light-guiding plate and the chassis so as to reflect the light, wherein the light-transmitting opening is placed at a position which deviates from a position of a positioning notch formed in the second optical member.

8. The display device according claim 1, wherein the light-transmitting opening includes an opening formed in the chassis and a shield member configured to regulate an area of the opening.

9. A backlight detecting method adapted to a display device in which light emitted from a light source positioned opposite to part of an edge of a light-guiding plate is guided into the light-guiding plate so as to illuminate a liquid crystal panel, wherein a light-transmitting opening having a rectangular shape is formed in a chassis covering the light source and the light-guiding plate at the edge of the liquid crystal panel, and wherein an optical sensor is used to receive the light reflected by the light-guiding plate so as to detect a quantity of received light.
